(19) United States
(12) Patent Application Publication
(10) Pub. No.: US 2022/0153559 A1
(43) Pub. Date: May 19, 2022

(54) CRANE, IN PARTICULAR MOBILE CRANE

(71) Applicant: TADANO FAUN GmbH, Lauf a. d. Pegnitz (DE)

(72) Inventors: Marco Kocian, Nuernberg (DE); Bernd Konheiser, Schwabach (DE)

(21) Appl. No.: 17/526,143

(22) Filed: Nov. 15, 2021

(30) Foreign Application Priority Data
Nov. 13, 2020 (DE) 10 2020 214 291.2

(51) Int. Cl. B66C 15/04; B66C 15/06; B66C 13/46; B66C 23/76

(52) U.S. Cl. CPC B66C 15/045; B66C 23/76; B66C 13/46; B66C 15/065

(57) ABSTRACT

A crane or mobile crane includes a crane base, a crane jib to be slewed relative to the base about a slewing axis vertically oriented in normal operating state. A counterweight carrier coupled to the crane jib slews therewith and carries counterweight modules in normal operating state. An anti-collision sensor system monitors the presence of an object within a slewing range ahead being passed through by the counterweight carrier and/or counterweight modules in the future during normal operation as the crane jib slews. A control unit linked to the anti-collision sensor system for signal transmission is configured to determine, based on sensor signals transmitted by the anti-collision sensor system, whether an object is present in the slewing range ahead, to determine whether the object can lead to a collision with the counterweight carrier or one counterweight module, and to take a countermeasure upon a collision.

### CROSS-REFERENCE TO RELATED APPLICATION

This application claims the priority, under 35 U.S.C. § 119, of German Patent Application DE 10 2020 214 291.2, filed Nov. 13, 2020; the prior application is herewith incorporated by reference in its entirety.

### FIELD AND BACKGROUND OF THE INVENTION

The invention relates to a crane, in particular a mobile crane.

A crane is a so-called lifting device used for lifting and moving loads. A large number of different constructions are known. Portal or bridge cranes have one or more beams forming a kind of bridge, on which a kind of trolley, which in turn carries a hoist, is movably disposed. Tower cranes are usually found in various constructions on construction sites. They have a vertical tower and, set at an angle thereto, a jib to which a hoist is attached. Tower cranes can be roughly divided into so-called “bottom slewing cranes” and “top slewing cranes.” In the case of a “bottom slewing crane,” the jib is connected non-rotatably to the tower, and the tower in turn is connected rotatably to a crane base. In the case of a “top slewing crane,” the tower is correspondingly attached, conversely, non-rotatably with the crane base and the jib is attached rotatably to the tower. Mobile cranes have a mobile crane base, usually in the form of a self-propelled undercarriage (e.g., a conventional truck or specially constructed chassis, which can be driven off-road to some extent), and a superstructure. The superstructure carries an inclinable and often also telescopic crane jib and is hinged so as to be rotatable (also “slewable”) relative to the undercarriage. Cranes with such a (usually asymmetrical) jib set at an angle to the crane base, i.e., in particular tower cranes and mobile cranes, hold a counterweight package in normal operation to compensate for the loads being picked up, specifically to stabilize tipping, usually on the side of the crane base facing away from the jib. The counterweight package is consequently also slewed when the crane jib is slewed.

Typically, the position of crane operators, particularly a crane driver in a cab, is located between the winch and the counterweight package, often making it difficult to see the counterweight package.

### SUMMARY OF THE INVENTION

It is accordingly an object of the invention to provide a crane, in particular a mobile crane, which overcomes the hereinafore-mentioned disadvantages of the heretofore-known cranes of this general type and which improves the operation of the crane.

With the foregoing and other objects in view there is provided, in accordance with the invention, a crane including a crane base and a crane jib that can be slewed relative to the crane base about a slewing axis that is vertically oriented in the normal operating state. Furthermore, the crane has a counterweight carrier which is coupled to the crane jib so as to slew therewith and on which a number of counterweight modules are disposed in the normal operating state. The, or each, counterweight module forms in particular (if necessary jointly) a counterweight package which serves to stabilize the crane boom, in particular to increase its tilt stability and to increase the permissible value of the weight force of a load to be lifted. The crane further includes an anti-collision sensor system, which serves to monitor the presence of any objects within a slewing range ahead, which will passed through by the counterweight carrier and/or the number of counterweight modules in the future during normal operation as the crane jib is slewed. In addition, the crane has a control unit which is linked to the anti-collision sensor system by using signal transmission and which is set up to determine, on the basis of sensor signals transmitted by the anti-collision sensor system, whether an object is present in the slewing range ahead, to determine whether the object can lead to a collision with the counterweight carrier or one of the possibly several counterweight modules, and to take a countermeasure in the event of a possible collision.

In other words, the control unit is set up or configured to monitor the slewing range of the counterweight package for a possible collision obstacle by using the anti-collision sensor system and to take a countermeasure if necessary. As described above, the slewing range “ahead” is understood to mean in particular the area or space adjacent to the counterweight package or the counterweight carrier, in front of the counterweight package or the counterweight carrier in the slewing direction. Due to this monitoring for a possible collision obstacle, the operation of the crane becomes safer, since the operator of the crane, in particular the crane driver, is relieved of monitoring tasks. In particular, the slewing range of the counterweight package is routinely difficult or impossible for the crane driver to see, since the counterweight package is usually located at the back of the crane driver and/or the view into this area is often obscured by the counterweight package or other crane superstructures.

Preferably, the crane is a mobile crane. In this case, the crane base is formed by an undercarriage, which has a running gear, preferably also a drive motor and a control station, in particular an operator's cab.

In a preferred embodiment, the control unit is set up to issue a warning message to operating personnel of the crane, preferably the crane driver, as a countermeasure. The warning message is audible and preferably also visual, in particular by showing on a display the position relative to the counterweight package of the object that could lead to a collision.

In addition or alternatively to the warning message, the control unit is expediently set up to stop a slewing drive (also: “slewing gear”) that performs the slewing movement of the crane boom, i.e., that slews the crane boom relative to the crane base. Optionally, this stopping is part of a multi-stage countermeasure sequence in which the control unit first outputs the warning message, which is optionally staggered in turn depending on the distance of the object from the counterweight package or the counterweight carrier (for example, by using different repetition frequencies of a warning tone), and then, in particular if there is no reaction from the crane driver and the distance of the object falls below a critical value, stops the slewing drive.

In an expedient embodiment, the anti-collision sensor system includes at least one proximity sensor. This is positioned in this case in such a way that an undesired approach of the object towards an outer edge of the counterweight carrier and/or at least of the lowest of possibly several counterweight modules lying in the direction of the slewing movement of the crane jib can be detected. In particular, this outer edge is an in particular short “side edge” of the counterweight module, which edge is, for example, plate-like (often also roughly rectangular or kidney-shaped). This short side edge is transverse (i.e., oblique or perpendicular) to the slewing direction (in particular describing a circle) of the crane jib during normal operation. Preferably, the proximity sensor is also set up to monitor a safety area around the ends of these edges.

In an expedient refinement, the anti-collision sensor system includes at least two proximity sensors positioned to monitor the opposite outer edges of the counterweight carrier or at least of the lowest counterweight module. Thus, in each of the two possible slewing directions (i.e., “right-hand” or “left-hand”), the range of motion, i.e., the slewing range of the counterweight package, can be monitored for a risk of collision. In some cases, counterweight modules are also used that have more than four corners, where corners routinely protrude in the slewing direction, i.e., the “outer edge” or “side edge” is bent. In this case, three or more proximity sensors are optionally also used along the bent side edge.

In a preferred embodiment, the proximity sensor or the two (or also more) proximity sensors described above are disposed on the counterweight module that is lowest during normal operation. In this case, they also have—in particular since the corresponding counterweight module(s) is/are disposed on the counterweight carrier only in normal operation—an interface which is set up to be reversibly coupled to a counter interface which is preferably disposed on the crane. In normal operation, the corresponding proximity sensor or sensors are reversibly connected to the control unit by using this interface. In a simple variant, this interface is cable-connected. Optionally, however, a wireless interface, e.g., a WLAN, RFID, NFC module or the like, is used.

In particular, in the event that several counterweight modules are disposed on the counterweight carrier during normal operation, at least one (further) proximity sensor is disposed on at least the uppermost counterweight module during normal operation in addition to the corresponding proximity sensor or sensors disposed on the lowermost counterweight module. In other words, proximity sensors are thus disposed on the intended lowest and uppermost counterweight module. As a result, at least the lower and upper outer edges can be monitored for collision. Further optionally, proximity sensors are also disposed on a counterweight module positioned normally between the uppermost and lowermost counterweight modules. This means that the entire stack height of the counterweight modules in normal operation can be monitored for a possible collision.

In one expedient embodiment, an ultrasonic sensor, a radar sensor, a LIDAR sensor, or a capacitive sensor is used as a proximity sensor.

In a further expedient embodiment, the anti-collision sensor system optionally includes at least one image sensor (preferably integrated in a camera) in addition to or as an alternative to the proximity sensors mentioned above. This image sensor is preferably positioned above the number of counterweight modules disposed on the counterweight carrier, i.e., above the counterweight package, at least in the normal operation of the crane. This enables optical, in particular visual, detection of the outer edges of all counterweight modules being used. In this case, the object is detected by using pattern recognition methods, for example.

In a particularly expedient embodiment, the control unit is set up to reject as an obstacle, at least as a function of the rotational position, an object of which the upper edge is disposed lower than the lower edge of the counterweight carrier and/or of the counterweight module that is disposed lowest during normal operation. In other words, the control unit does not consider objects that lie below a slewing plane of the counterweight package or counterweight carrier to be an obstacle, since the slewing movement of the counterweight package or counterweight carrier “runs over” such an object. In principle, such an “assessment” of whether it is possible to swing over the corresponding object can be made over the complete circle that can be traversed during normal operation. In particular, in the event that safety requirements also preclude such overhead swinging, at least for living creatures, the control unit is set up to reject any detected part of the crane base as a collision-relevant obstacle, at least for the rotational positions in which the counterweight package or the counterweight carrier sweeps over parts of the crane base, i.e., the undercarriage in the case of the mobile crane. In the remaining parts of the slewing range, any object can then be regarded as collision-relevant.

In addition or as an alternative to the embodiment described above, the proximity sensor or at least one proximity sensor disposed accordingly on the underside is set up in such a way that areas below the counterweight package or counterweight carrier, if necessary below an additional tolerance or safety area, are excluded (or “blanked out”) from the area that can be detected by using the proximity sensor. In the case of capacitive proximity sensors, for example, this is made possible by shaping the electrical measurement field accordingly, in particular by using guard electrodes, and in the case of LIDAR sensors by optical barriers or the like.

In an embodiment that is advantageous in terms of the crane's ease of operation, the control unit is set up to display the position of the object from a bird's eye view to the operator of the crane (in particular, the crane driver). In particular, the control unit creates a (e.g., virtual) view of the crane from the bird's eye view on a screen and displays the object—at least a placeholder if the contour of the object is not known (e.g., in the case of ultrasonic or capacitive sensors)—at the detected position. Alternatively, the control unit only indicates at which point of the counterweight package or counterweight carrier a collision is imminent, e.g., by using differently color-coded areas around the counterweight package or counterweight carrier. Optionally, the control unit also creates a side view of the crane so that the operator can judge for himself or herself whether he or she can or may slew the crane over the object. In case at least one image sensor above the counterweight package is used, a real camera image of the counterweight package or counterweight carrier is displayed.

In the context of the invention, the control unit can be constructed as a non-programmable electronic circuit and in this case can be integrated, for example, in a controller of the crane. Preferably, however, the control unit (also referred to as a “controller”) is formed by a microcontroller in which the functionality of the above-described monitoring of the slewing range for a possible collision is implemented in the form of a software module. In particular, this software module can in turn form a component of an overarching control software of the control system of the crane.

The conjunction “and/or” is to be understood in this case and in the following in particular in such a way that the features linked by using this conjunction can be formed both together and as alternatives to each other.

Other features which are considered as characteristic for the invention are set forth in the appended claims.

Although the invention is illustrated and described herein as embodied in a crane, in particular a mobile crane, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, top-plan view of a crane;

FIG. 2 is a side-elevational view of the crane according to FIG. 1; and

FIG. 3 is a view similar to FIG. 2 of a further exemplary embodiment of the crane.

### DETAILED DESCRIPTION OF THE INVENTION

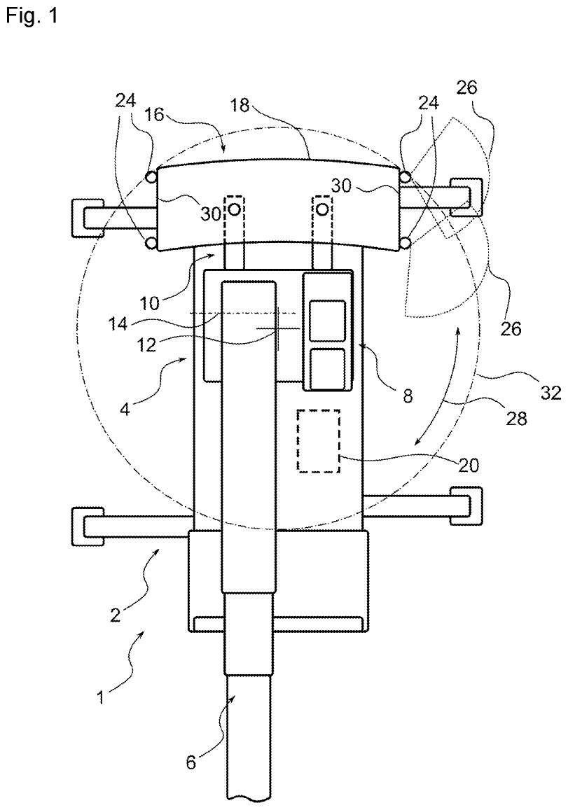

Referring now in detail to the figures of the drawings, in which corresponding parts are always provided with the same reference symbols, and first, particularly, to FIG. 1 thereof, there is seen a diagrammatic illustration of a crane 1, in this case specifically a mobile crane. The crane 1 has an undercarriage 2 as a crane base. In addition, the crane 1 has a superstructure 4, which supports a telescopic crane jib 6, a driver's cab 8 and a counterweight carrier 10. The superstructure 4 is articulated to the undercarriage 2 so as to be rotatable about a slewing axis 12 (perpendicular to the undercarriage) by using a so-called slewing drive (not shown). The crane jib 6 is in turn articulated to the superstructure 4 so that the jib can tilt or “luff” about a horizontally oriented luffing axis 14.

In normal operation of the crane 1, a counterweight package 16 is disposed on the counterweight carrier 10 and is formed from a number of counterweight modules 18—in this case by way of example in the form of roughly rectangular plates. Depending on the use of the crane 1, specifically depending on the loads to be lifted and/or depending on the crane configuration, i.e., for example, the length and inclination of the crane jib 6, more or fewer counterweight modules 18 are used.

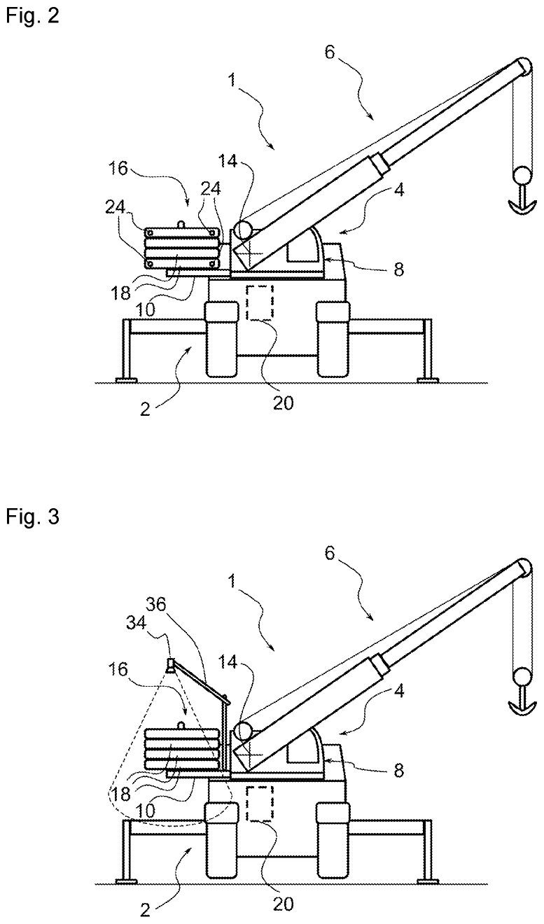

Operating personnel of the crane 1, specifically a crane driver, are usually located in the driver's cab 8 during normal operation, so that the seating direction and thus the main viewing direction is oriented parallel to the crane jib 6 and in the direction of a crane hook (i.e., downwardly in FIG. 1, and to the right in FIGS. 2 and 3). This makes it difficult to see areas behind the superstructure 4, specifically to the sides next to and behind the counterweight package 16. In order to increase the operational safety of the crane 1 and at the same time relieve the crane driver, the crane 1 has a control unit 20 that is set up to detect possible collisions of the counterweight package 16—or, for example, only of the counterweight carrier 10 in the unequipped state—and to take countermeasures.

For this purpose, the crane 1 also has an anti-collision sensor system, which in the exemplary embodiment according to FIGS. 1 and 2 includes several proximity sensors 24. In the present exemplary embodiment, these proximity sensors 24, for example ultrasonic sensors, are disposed at the corners of the lowest counterweight module 18 and—see FIG. 2—also of the uppermost counterweight module 18 of the counterweight package 16. The proximity sensors 24 are set up in this case to monitor a measuring area 26 (schematically shown in FIG. 1 only on one side of the counterweight module 18) for the presence of an object. This measuring area 26 is located in front of the particular outer edge 30 of the counterweight module 18 in each case in the slewing direction 28. The two measuring areas 26 shown in FIG. 1 are thus located in front of the counterweight module 18 when the superstructure 4 (and thus the crane jib 6) slews in a clockwise direction.

The proximity sensors 24 are connected to the control unit 20 in terms of signal transmission (not shown). The control unit 20 is set up in this case to evaluate the signals of the proximity sensors 24 to determine whether an object is located in a slewing range 32 of the counterweight package 16 and to determine whether that object can lead to a collision with the counterweight package 16. This is routinely the case if the object is detected within the swivel range 32. Objects disposed outside the swivel range 32—possibly plus a safety range extending beyond it, which is not shown—but detected by the proximity sensors 24, are not considered to be collision-critical.

Optionally, the control unit 20 is set up to identify whether the detected object is the undercarriage 2. This does not represent a collision risk either. In addition, the control unit 20 is optionally set up to determine whether an upper edge of the object is disposed below the counterweight package 16 and the lowest counterweight module 18, and can thus be swung over.

In a non-illustrated embodiment, proximity sensors 24 are also disposed on the counterweight carrier 10 so as to be able to prevent a possible collision in the event of slewing without a counterweight package 16.

FIG. 3 shows another exemplary embodiment of the crane 1. Instead of the proximity sensors 24, the anti-collision sensor system in this case includes an image sensor, specifically a camera 34. This camera is disposed on a frame 36 above the counterweight package 16 so that the outer edges 30 can be monitored. Optionally, a camera 34 is associated in this case with each outer edge 30.

In this exemplary embodiment, the control unit 20 evaluates the camera images using pattern recognition to detect possible obstacles in the slewing range 32.

In all of the exemplary embodiments described above, the control unit 20 is set up or configured to issue a warning to the crane driver at the latest when a collision hazard is identified and—optionally in the absence of a reaction to the warning—to stop the slewing drive of the crane 1.

The subject matter of the invention is not limited to the exemplary embodiments described above. Rather, further embodiments of the invention can be derived by a person skilled in the art from the foregoing description.

The following is a summary list of reference numerals and the corresponding structure used in the above description of the invention:

### LIST OF REFERENCE SIGNS

1 crane
2 undercarriage
4 superstructure
6 crane jib
8 driver's cab
10 counterweight carrier
12 slewing axis
14 luffing axis
16 counterweight package
18 counterweight module
20 control unit
24 proximity sensor
26 measuring area
28 slewing direction
30 outer edge
32 slewing range
34 camera
36 frame

1. A crane or a mobile crane, comprising:
a crane base;
a crane jib to be slewed relative to said crane base about a slewing axis being vertically oriented in a normal operating state;
a counterweight carrier coupled to said crane jib so as to slew with said crane jib, and a number of counterweight modules disposed on said counterweight carrier in the normal operating state;
an anti-collision sensor system for monitoring a presence of an object within a slewing range ahead, said slewing range configured to be passed through by at least one of said counterweight carrier or said number of counterweight modules during future normal operation as said crane jib is slewed; and
a control unit linked to said anti-collision sensor system for signal transmission, said control unit configured to determine, based on sensor signals transmitted by said anti-collision sensor system, a presence of an object in said slewing range ahead, to determine whether the object can lead to a collision with said counterweight carrier or at least one of said counterweight modules, and to take a countermeasure in an event of a possible collision.

2. The crane according to claim 1, wherein said control unit is configured to issue a warning message to operating personnel of the crane to at least one of provide a countermeasure or stop a slewing drive performing a slewing movement of said crane jib.

3. The crane according to claim 1, wherein said anti-collision sensor system includes at least one proximity sensor positioned to detect an undesired approach of the object towards an outer edge, lying in a direction of a slewing movement, of at least one of said crane jib, said counterweight carrier, a lowermost counterweight module, or at least one of said counterweight modules.

4. The crane according to claim 3, wherein said anti-collision sensor system includes at least two proximity sensors positioned to monitor opposite outer edges of said counterweight carrier, or said lowermost counterweight module, or said at least one of said counterweight modules.

5. The crane according to claim 1, wherein said anti-collision sensor system includes a proximity sensor disposed on one of said counterweight modules being lowest during normal operation, and said proximity sensor is connected to said control unit during normal operation by a reversibly couplable interface.

6. The crane according to claim 5, wherein a plurality of said counterweight modules are disposed on said counterweight carrier during normal operation, and said proximity sensor is at least one proximity sensor disposed at least on one of said counterweight modules being uppermost during normal operation.

7. The crane according to claim 1, wherein said anti-collision sensor system includes a proximity sensor being an ultrasonic sensor, a radar sensor, a LIDAR sensor or a capacitive sensor.

8. The crane according to claim 1, wherein said anti-collision sensor system includes at least one image sensor positioned above said number of counterweight modules disposed on said counterweight carrier during normal operation, to permit an optical detection of outer edges of all of said counterweight modules being used.

9. The crane according to claim 1, wherein said control unit is configured to reject as an obstacle, at least as a function of a rotational position, an object having an upper edge disposed lower than a lower edge of at least one of said counterweight carrier or one of said counterweight modules being lowest in normal operation.

10. The crane according to claim 1, wherein said control unit is configured to display a position of the object from a bird's eye view to an operator of the crane.
